(19) United States
(12) Patent Application Publication
(10) Pub. No.: US 2010/0078958 A1
(43) Pub. Date: Apr. 1, 2010

(54) Roof Retracting Device and Vehicle Equipped with the Same

(76) Inventors: Dehe Mao, Shenzhen (CN); Hu Man, Shenzhen (CN); Hongfei Yan`, Shenzhen (CN); Yi Qin, Shenzhen (CN); Tao Liu, Shenzhen (CN)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/568,606

(22) Filed: Sep. 28, 2009

(30) Foreign Application Priority Data
Sep. 27, 2008 (CN) 200820137021.8

(51) Int. Cl. B60J 7/20; B60J 7/08; B60J 7/12

(52) U.S. Cl. 296/107.08

(57) ABSTRACT

The present invention discloses a roof retracting device, the roof retracting device comprises a driving shaft, a rear frame, a trunk cover, a main axle, a first lever, a second lever extending transversely from one end of the driving shaft, and a connecting lever, wherein the driving shaft rotates around the main axle, and drives a roof to move between an extended position and a retracted position; the rear frame opens for the passage of the roof, and closes to seal a space between the roof and the trunk cover; the first lever connects to the second lever, and rotates around the main axle; and the connecting lever connects the first lever to the rear frame. The rear frame operates harmoniously with the driving shaft via the first lever, the second lever and the connecting lever.

### CROSS-REFERENCE TO RELATED APPLICATION

This application claims priority to and benefit of Chinese Patent Application Serial No. 200820137021.8, filed in the State Intellectual Property Office of the P.R. China on Sep. 27, 2008.

### BACKGROUND OF THE INVENTION

1. Field of the Invention

The present invention relates to a vehicle, and in particular, relates to a roof retracting device and a vehicle equipped with the same.

2. Background of the Related Art

With the advancement of the society and the development of the economy, convertible vehicles become more and more popular in our lives. The roof of the convertible vehicle should satisfy the sealing requirement when the roof opens as in an enclosed vehicle, and should ensure safety and stability when the roof opens and retracts.

Compared to a vehicle equipped with triple-folded roof, a vehicle equipped with double-folded roof has simpler configuration, but requires a longer trunk to accommodate the folded roof. However, it is more difficult to drive a vehicle which has a longer body. Therefore, to accommodate a long roof in a short trunk, a roof retracting device is needed to fold the roof and satisfy the sealing requirement.

A retractable hardtop roof is disclosed in the Chinese patent publication CN1293122A. The retractable hardtop roof comprises an upper roof section and a rear roof section. The upper roof section and the rear roof section are connected via a connecting rod assembly. When retracting the roof into a folded position, the upper roof section moves into the interior of the rear roof section, and retracts together with the rear roof section into the accommodation space. This patent application does not consider the sealing requirement when the roof opens and retracts.

A retractable hardtop roof of a convertible vehicle is disclosed in the Chinese patent CN2880565Y. The retractable hardtop roof comprises a base, a first connecting rod which is connected to the front of the base, a second connecting rod which is connected to the rear of base, a third connecting rod which connects the first connecting rod and the second connecting rod. The second connecting rod comprises a rear connecting rod and a front connecting rod, wherein the rear connecting rod is connected to the front connecting rod. During the operation of the roof, the hydraulic actuator drives each of the connecting rods, and moves the roof between the extended position on the roof of the vehicle and the retracted position in the accommodation space. However, this patent application does not consider the sealing structure as well. Thus, the movement of the roof influences the appearance of the vehicle, and does not meet the aerodynamic needs.

A retractable roof device and a vehicle equipped with the same are disclosed in the Chinese patent publication CN1750952A. The retractable roof device comprises a rear cover. The rear cover comprises a rear frame and two closure flaps located on both sides of the rear frame. The rear cover can be moved to make room for the passage of the roof and the guiding means of the roof when the roof moves between the extended position and the retracted position. The rear cover provides a sealing structure when the roof is in the extended position or in the retracted position. The rear cover operates together with the roof. Specifically, the extension of the guiding means of the roof causes rotation of the cam. Then, the cam actuates the rear cover to move via an L-shape lever. With continuous rotation of the guiding means of the roof, the extension of the guiding means comes into contact with the pulley, and causes the rotation of the pulley. The rotation of the pulley generates a driving force on a cable fixed on the pulley. At the other end of the cable, the driving force acts on an actuating mechanism of the closure flaps, and further causes the opening or closing of the closure flaps. But a vehicle equipped with the retractable roof device suffers from many disadvantages. First, the roof retractable device causes the inconsistency of the starting points of the parts, and the derail of the pulley cable. As a result, the rear frame may rupture and the roof may stop moving. Second, the configuration of the roof retractable device is complicated and needs high accuracy to manufacture and assemble. Third, it is difficult to adjust the inter-operation between the trunk cover and the roof. Fourth, the operation of the roof retractable device is not stable.

### SUMMARY OF THE INVENTION

The present invention provides an improved roof retracting device with a simple structure, and better reliability and stability in operation.

According to some embodiments of the present invention, a roof retracting device comprises a driving shaft, a rear frame, a trunk cover, a main axle, a first lever, a second lever extending transversely from one end of the driving shaft, and a connecting lever. The driving shaft is configured to rotate around the main axle, and drive a roof to move between an extended position and a retracted position; the rear frame is configured to open for the passage of the roof, and close to seal the space between the roof and the trunk cover. The first lever is configured to connect to the second lever, and rotate around the main axle; and the connecting lever is configured to connect the first lever and control the open or closure of the rear frame.

According to another embodiment, the present invention discloses a vehicle which is equipped with the same roof retracting device.

In some embodiment of the present invention, the rear frame operates in concert with the driving shaft via a first lever, a second lever and a connecting lever. As a result, the structure of the roof retracting device is simple as well as more reliable and stable.

### BRIEF DESCRIPTION OF THE DRAWINGS

The aforementioned features and advantages of the present invention as well as the additional features and advantages thereof will be more clearly understood hereinafter as a result of a detailed description of embodiments when taken in conjunction with the drawings.

FIG. 1 is a perspective view illustrating an embodiment of a roof retracting device.

### DESCRIPTION OF THE EMBODIMENTS

According to the present invention, the roof retracting device comprises a

driving shaft 1, a rear frame 2, a trunk cover, a main axle 3, a first lever 5, a second lever 7 extending from one end of the driving shaft 1, and a connecting lever 6. The driving shaft 1 rotates around the main axle 3, and drives a roof to move between an extended position and a retracted position; the rear frame 2 opens for the passage of the roof, and closes to seal the space between the roof and the trunk cover; the first lever 5 connects to the second lever 7, and rotates around the main axle 3; and the connecting lever 6 connects the first lever 5 and controls the open or closure of the rear frame 2.

The driving shaft 1 is driven by a hydraulic actuator or a pneumatic actuator to rotate around the main axle 3 such that the roof of a vehicle moves between an extended position and a retracted position. At the extended position, the roof unfolds entirely and rests on top of the vehicle frame. The vehicle then acts as a regular vehicle. At the retracted position, the roof is retracted or folded into a trunk. The vehicle then acts as a convertible vehicle. The trunk cover may open backward so that the roof can be retracted into the trunk. The trunk cover may also open forward so that the luggage can be loaded into the trunk.

The rear frame 2 may be in an opened position and in a closed position. When the rear frame 2 is in the opened position, it makes space for the passage of the roof so that the roof may move between the extended position and the retracted position. When the rear frame 2 is in the closed position, it seals the space between the vehicle roof and the trunk cover to improve the vehicle's exterior design and aerodynamic feature.

Generally, the rear frame 2 operates together with the roof. Specifically, the second lever 7 extends transversely from one end of the driving shaft 1. The second lever 7 may be engaged with and disengaged from a radial protruding part of the first lever 5 to drive the first lever 5 to rotate around the main axle 3. The first lever 5 is connected to the rear frame 2 via an L-shape connecting lever 6. Accordingly, the first lever 5 may rotate to open or close the rear frame 2 via the connecting lever 6.

According to an embodiment of the invention, the first lever 5 comprises a radial cam which is part of the first lever 5 (not shown in the drawing). The roof retracting device also comprises a resetting lever 12, which may be selectively engaged with and disengaged from the radial cam of the first lever 5. The resetting lever 12 contacts the radial cam of the first lever 5, and drives the first lever 5 to rotate and close the rear frame 2, after the roof retracts into the trunk. The roof retracting device also comprises a resetting spring, which is connected to the first lever 5. Before the roof unfolds from the trunk, the resetting lever 12 is disengaged from the cam. The first lever 5 is driven by the elastic force of the resetting spring to rotate and open the rear frame 2. In some embodiment, the resetting lever 12 operates together with the trunk cover. For example, the resetting lever 12 operates together with the trunk cover via a cable. When the trunk cover is closed, the resetting lever 12 contacts the cam of the first lever 5 to close the rear frame 2. When the trunk cover is open, the resetting lever 12 is disengaged from the cam in order to open the rear frame 2 via the resetting spring.

The operation of the roof retracting device during retraction or folding of the roof is detailed in the following manner.

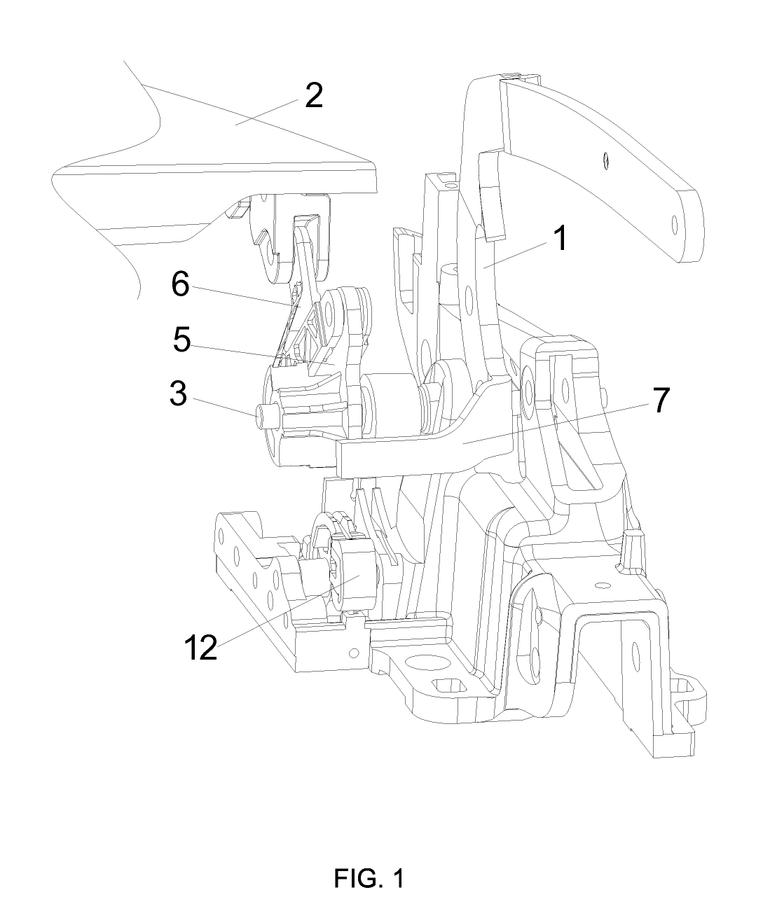

The trunk cover is opened before the roof retracts into the trunk. When the trunk cover opens, the resetting lever 12 rotates in a counter-clockwise direction by a connecting mechanism such as a cable as shown in FIG. 1, i.e., the resetting lever 12 rotates upwards.

Then the driving mechanism such as a hydraulic assembly and a pneumatic assembly is turned on to drive the driving shaft 1 to rotate around the main axle 3 in order to retract or fold the roof. After the driving shaft 1 rotates and before the roof retracts into the trunk, the second lever 7 drives the first lever 5 to rotate in the counter-clockwise direction. The rotation of the first lever 5 drives the rear frame 2 to open so that the roof can be retracted into the trunk.

The roof retracts into the trunk completely when the driving shaft 1 reaches a terminal point. Then, the trunk cover can be closed. When the trunk cover moves from the opened position to the closed position, the resetting lever 12 is driven by a connecting mechanism such as a cable to rotate in a clockwise direction. The resetting lever 12 gets contact with the cam of the first lever 5. The first lever 5 then rotates in the counter-clockwise direction. The rotation of the first lever 5 drives the rear frame 2 to close via the connecting lever 6. When the trunk cover is completely closed, the rear frame 2 closes to seal the space left in the front of the trunk cover. Then, the retraction of the roof completes.

The operation of the roof retracting device during unfolding of the roof is detailed in the following manner.

The trunk cover is opened backward to unfold the roof from the trunk. During the opening process of the trunk cover, the resetting lever 12 is driven by the trunk cover to rotate upwards. At this moment, the first lever 5 is reset by the resetting spring because there is lack of a pushing force from the resetting lever 12 against the first lever 5. Namely, the first lever 5 rotates in the clockwise direction. The first lever 5 drives the rear frame 2 to move backward to the closed position via the connecting lever 6.

And then, the driving shaft 1 is driven by the driving mechanism to rotate in the clockwise direction and move the roof out of the trunk. The second lever 7 drives the first lever 5 to rotate in the clockwise direction. The first lever 5 moves the rear frame 2 to the closed position via the connecting lever 6.

And then, the driving shaft 1 continues rotating in the clockwise direction to unfold the roof. When the roof opens entirely and rests on top of the vehicle frame, the trunk cover is closed. During the closing process of the trunk cover, the resetting lever 12 rotates to an original position as shown in FIG. 1. Thus, the unfolding of the roof completes.

In order to improve the exterior design and the aerodynamic features of vehicles, the closure flaps may be mounted on both sides of the rear frame 2 or the trunk cover. When the roof is at the extended position, the closure flaps retract to make space for the passage for the joint among the C-pillars, the trunk cover and the sides of the vehicle body. When the roof is at the retracted position, the closure flaps open in order to seal the space left (i.e., the joint among the C-pillars, the trunk cover and the sides of the vehicle body) on both sides of the trunk cover. The flaps may be independently driven by a respective driving device or may operate together with the trunk cover or the rear frame 2.

The principles of the preferred embodiment described herein is therefore illustrative and not restrictive, the scope of the invention being indicated in the appended claims and all variations which come within the spirit and meaning of the claims are intended be embraced therein.

What is claimed is:

1. A roof retracting device comprising:
a driving shaft;
a rear frame;
a trunk cover;
a main axle;
a first lever;
a second lever extending transversely from one end of the driving shaft; and
a connecting lever; wherein
the driving shaft is configured to rotate around the main axle, and drive a roof to move between an extended position and a retracted position;
the rear frame is configured to open for the passage of the roof, and close to seal a space between the roof and the trunk cover;
the first lever is configured to connect to the second lever, and be driven by the second lever to rotate around the main axle; and
so as to control the open or closure of the rear frame.

2. The roof retracting device according to claim 1, wherein the connecting lever is configured to engage the first lever and open the rear frame, when the driving shaft drives the roof from the extended position to the retracted position.

3. The roof retracting device according to claim 2, wherein the connecting lever is configured to engage the first lever and close the rear frame, when the driving shaft drives the roof from the retracted position to the extended position.

4. The roof retracting device according to claim 3, further comprising a resetting lever, wherein the resetting lever is configured to engage a cam of the first lever, the cam is driven by the engaged resetting lever to rotate and close the rear frame, after the roof retracts into a trunk.

5. The roof retracting device according to claim 4, further comprising a resetting spring connected to the first lever, wherein the resetting lever is configured to disengage from the cam of the first lever, the cam is driven by the resetting spring to rotate and open the rear frame, before the roof unfolds from the trunk.

6. The roof retracting device according to claim 5, wherein the resetting lever is configured to inter-operate with the trunk cover, wherein closing the trunk cover causes the engagement of the resetting lever with the cam of the first lever to close the rear frame; and opening the trunk cover causes the disengagement of the resetting lever from the cam of the first lever to open the rear frame via the resetting spring.

7. A vehicle, wherein the vehicle includes the roof retracting device according to claim 1.

8. A vehicle, wherein the vehicle includes the roof retracting device according to claim 2.
